(19) United States
(12) Patent Application Publication
(10) Pub. No.: US 2012/0175926 A1
(43) Pub. Date: Jul. 12, 2012

(54) KING OF THE HOUSE FURNITURE COVERING SYSTEMS

(76) Inventor: Kevin McKinney, Pelham, AL (US)

(21) Appl. No.: 13/342,265

(22) Filed: Jan. 3, 2012

Related U.S. Application Data
(60) Provisional application No. 61/431,725, filed on Jan. 11, 2011.

(51) Int. Cl. A47C 31/11; G09F 3/00

(52) U.S. Cl. 297/220; 40/320

(57) ABSTRACT

A furniture covering system comprising a coverings assembly including: at least two arm sleeves that cover arms of a furniture item; a headrest cover that covers a headrest of the furniture item; a footrest cover that covers a footrest of the furniture item; a padded seat cover having a zipper that covers a seat of the furniture item; and a fastening system. The fastening system comprises a set of elastic straps and hook and loop fasteners to attach the coverings assembly to the furniture item. The coverings assembly comprises markings having indicia to provide a visual indication of who is permitted to sit in the furniture item. Further, the indicia is inter-changeable as desired by the occupant. The coverings assembly is stain-resistant and provides comfort for the occupant of the furniture item thereby preventing undue wear of the furniture item.

### CROSS-REFERENCE TO RELATED APPLICATION

The present application is related to and claims priority from prior provisional application Ser. No. 61/431,725, filed Jan. 11, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The following includes information that may be useful in understanding the present invention(s). It is not an admission that any of the information provided herein is prior art, or material, to the presently described or claimed inventions, or that any publication or document that is specifically or implicitly referenced is prior art.

The present invention relates generally to the field of coverings and more specifically relates to a novel furniture covering system.

2. Description of the Related Art

Furniture such as chairs and beds are used in many modern day residences for sitting and sleeping in. These chairs and beds provide comfort for occupants while engaging in activities such as watching television. A significant number of individuals have favorite reclining chairs, in which they frequently sit. Consistent and prolonged use of these chairs may lead to the development of stains and worn areas in the fabric. This can be unsightly and uncomfortable. Also, individuals may grow tired of the patterns or colors embellishing their chairs as these patterns may go out of style while the furniture item is still functional. It is desirable that furniture items be protected from undue wear and maintain a pleasing aesthetic appearance.

Various attempts have been made to solve the above-mentioned problems such as those found in U.S. Pat. And Pub. Nos. 2001/0001188; D23066; 190,788; D187,917; D384826; and 811,138. This prior art is representative of furniture and coverings. None of the above inventions and patents, taken either singly or in combination, is seen to describe the invention as claimed.

Ideally, a furniture covering system should be aesthetically pleasing and protect furniture from wear and, yet would operate reliably and be manufactured at a modest expense. Thus, a need exists for a reliable furniture covering system to avoid the above-mentioned problems.

### BRIEF SUMMARY OF THE INVENTION

In view of the foregoing disadvantages inherent in the known coverings art, the present invention provides a novel furniture covering system. The general purpose of the present invention, which will be described subsequently in greater detail is to provide longevity of furniture items covered by the instant invention.

King of the House Easy Chair Set allows consumers to increase the comfort and style of their favorite furniture, most specifically reclining chairs. This innovative product preferably features cloth assemblies designed to drape over the headrest, arms, and footrest portions of a chair (or other furniture item.) For optimal comfort, a padded sheet encased in a removable, pillow case-like covering is provided which can be applied to the seat. This invention can be made in a royal color scheme, including purple, gold, red and white, and can be embellished with images of crowns. Interchangeable covers bearing holiday, sports, and special occasion themes in other colors may also be available.

A furniture covering system is disclosed herein in a preferred embodiment comprising a coverings assembly including: at least two arm sleeves; a headrest cover; a footrest cover; a padded seat cover; and a fastening system. The arm sleeves cover the arms of a furniture item. The headrest cover covers a headrest of the furniture item. The footrest cover covers a footrest (if present) of the furniture item. The padded seat cover covers a seat of the furniture item. The padded seat cover preferably comprises a zipper and removable padding to promote comfort of an occupant as per user-preference. The fastening system comprises a set of elastic straps and hook and loop fasteners to attach the coverings assembly to the furniture item in preferred embodiments.

The furniture item may comprise a reclining chair, a non-reclining chair or other such furniture item. The coverings assembly preferably comprises distinctive ‘markings’ having indicia to provide a visual indication of whom is permitted to sit in the furniture item. Further, the indicia may be inter-changeable as desired by the occupant. The coverings assembly is stain-resistant and provides comfort for the occupant of the furniture item also preventing undue wear of said furniture item.

A kit is disclosed herein for a novel coverings assembly including; at least two arm sleeves; a headrest cover; a footrest cover; a padded seat cover; and a fastening system. The covering items preferably comprise indicia of a user's preference.

A method of use for a furniture covering system is also described herein comprising the steps of: covering arms, headrest, footrest and a seat of a furniture item with a covering assembly; attaching the covering assembly using a fastening system to the furniture item; and thereby preventing undue wear to the furniture item when used. The method may further comprise the step of displaying indicia on the covering assembly to indicate a proper occupant of the furniture item.

The present invention holds significant improvements and serves as a furniture covering system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, furniture covering system, constructed and operative according to the teachings of the present invention.

FIG. 1 shows a perspective view illustrating a furniture covering system in an in use condition according to an embodiment of the present invention.

FIG. 2 is a perspective view illustrating the furniture covering system as usable on a chair according to an embodiment of the present invention of FIG. 1.

FIG. 3 is a perspective view illustrating arm sleeves, headrest cover, footrest cover, padded seat cover and fastening system of the furniture covering system according to an embodiment of the present invention of FIG. 1.

FIG. 4 is a perspective view illustrating the furniture covering system according to an alternate embodiment of the present invention of FIG. 1.

FIG. 5 is a flowchart illustrating a method of using the furniture covering system according to embodiments of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a covering device and more particularly to a furniture covering system as used to promote the longevity of furniture and to improve its aesthetic appearance.

Generally speaking, ‘king of the house easy chair set’ (furniture covering system) is designed to allow consumers to protect their favorite chairs while adding style and comfort. The invention may comprise a set of stain-resistant, fabric assemblies designed to be placed on various parts of a chair or other such furniture item. Included in the set can be arm sleeves, a headrest cover, a footrest cover, and a padded seat component. The pad of the seat component can be encased in a pillow case-like covering with a zipper enclosure, which may be easily removed and reapplied as needed. Users may switch the pad case for other cases embellished with different designs and colors to coincide with various occasions, sports teams, and other individual preferences.

A series of elastic straps containing hook and loop fasteners may be applied to the frame of the furniture in order to keep the seat component secured into place to prevent wear to the furniture item. The side arm sleeves for example can lay across chair arms and the headrest component may comprise a thin, lightweight throw-style piece. The footrest component can be secured to the footrest of the chair via elastic straps with hook and loop fasteners or suitable equivalent fastening means, which may be concealed when the footrest is down. This invention can be made in a royal color scheme (purple, red, gold, and white) in preferred embodiments, and can include an image of a crown. Alternative furniture covering sets may be available in a variety of colors and designs, embellished with images of sports team logos, holiday-themed items, and other images to coincide with various events and user preferences. The system can be used on virtually any style chair and in any room. Other furniture items such as sofas and the like may be covered using different sized and shaped furniture covers.

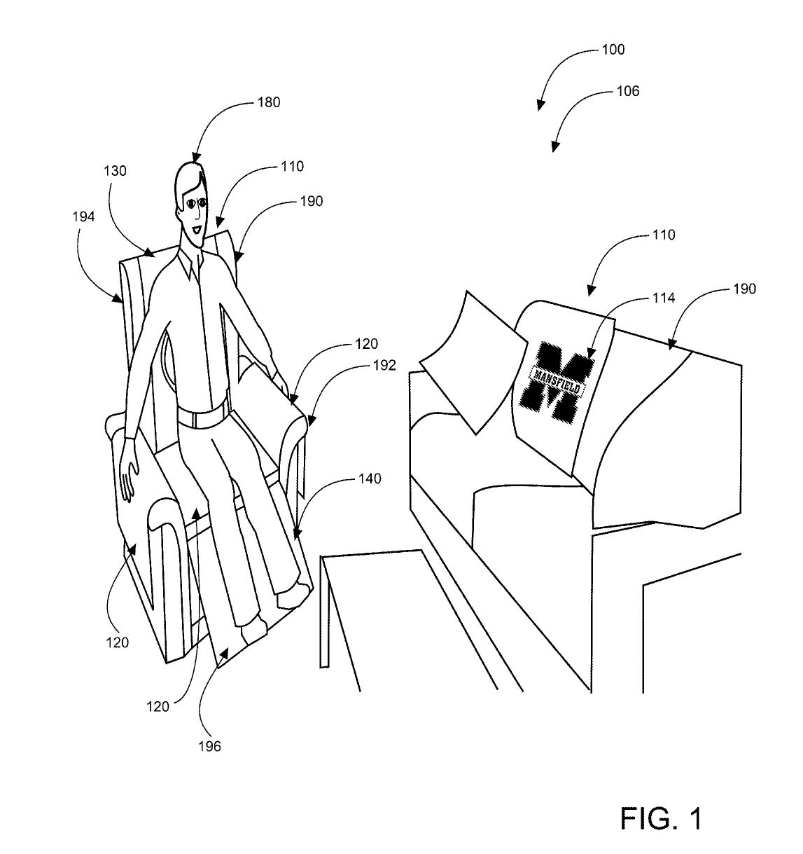

Referring to the drawings by numerals of reference there is shown in FIG. 1, a perspective view illustrating a furniture covering system 100 in ‘in use’ condition 106 according to an embodiment of the present invention.

Furniture covering system 100 preferably comprises: coverings assembly 110 including; at least two arm sleeves 120; headrest cover 130; footrest cover 140; and padded seat cover 150. Arm sleeves 120 cover arms 192 of furniture item 190. Headrest cover 130 covers headrest 194 of furniture item 190. Footrest cover 140 covers footrest 196 of furniture item 190. Padded seat cover 150 covers seat 198 of furniture item 190. Coverings assembly 110 is substantially stain-resistant. Further, coverings assembly 110 provides comfort for occupant 180 of furniture item 190 and prevents undue wear of furniture item 190.

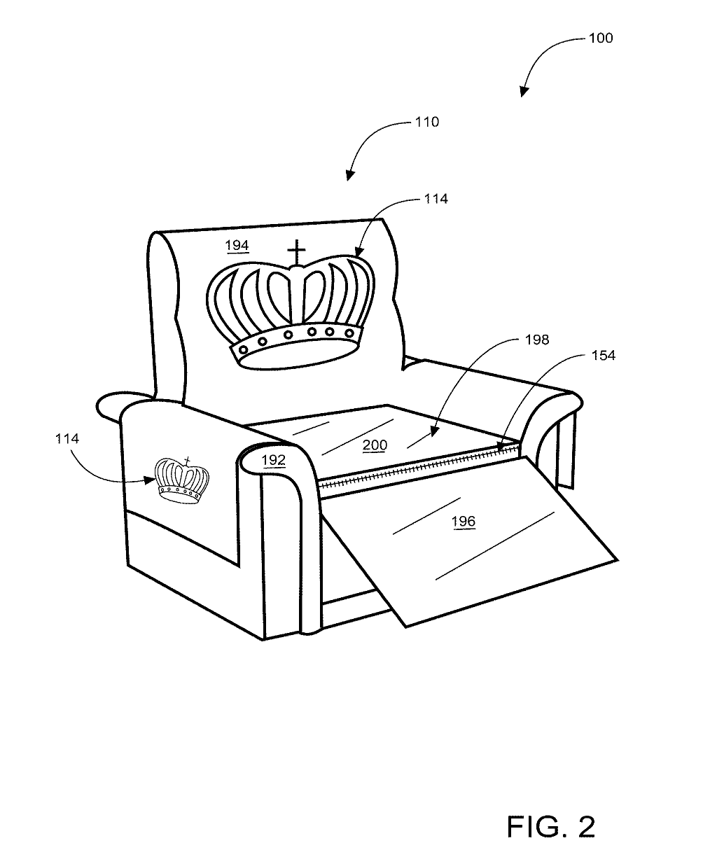

Referring now to FIG. 2, a perspective view illustrating furniture covering system 100 as usable on chair 200 according to an embodiment of the present invention of FIG. 1.

Furniture item 190 may comprises chair 200. Chair 200 may comprise a recliner or non-recliner. Upon reading this specification, it should be appreciated that, under appropriate circumstances, considering such issues as user preferences, design preference, structural requirements, marketing preferences, cost, available materials, technological advances, etc., other furniture item arrangements such as, for example, couches, loveseats etc., may be sufficient.

Coverings assembly 110 further comprises fastening system 210 in preferred embodiments. Fastening system 210 may comprise a set of elastic straps 220 and/or hook and loop attachers 230. Fastening system 210 may comprise a combination of elastic straps 220 and hook and loop attachers 230 to maximize coupling of the present invention to furniture item 190. Upon reading this specification, it should be appreciated that, under appropriate circumstances, considering such issues as user preferences, design preference, structural requirements, marketing preferences, cost, available materials, technological advances, etc., other attaching means and arrangements such as, for example, snaps, buttons, etc., may be sufficient.

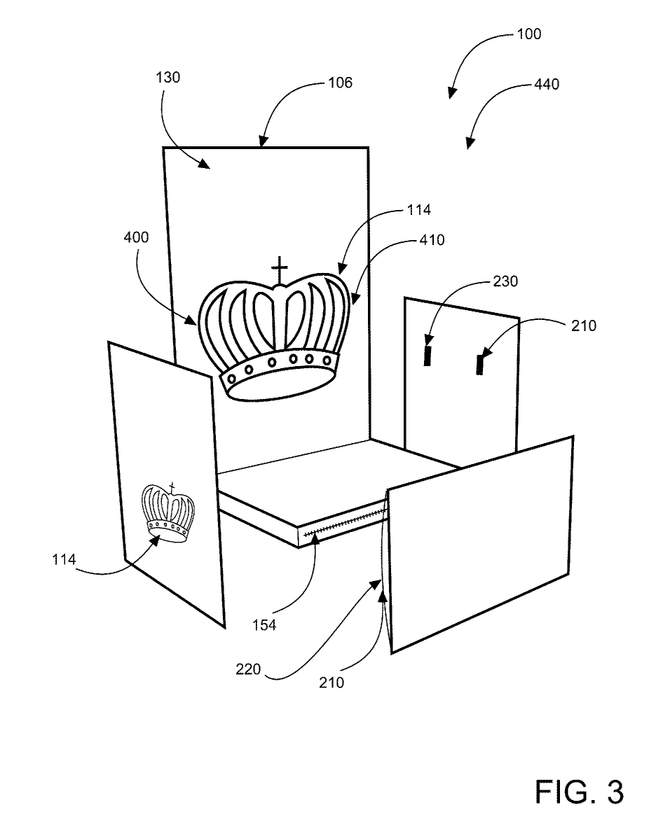

Referring now to FIG. 3, a perspective view illustrating arm sleeves 120, headrest cover 130, footrest cover 140, padded seat cover 150 and fastening system 210 of the furniture covering system 100 according to an embodiment of the present invention of FIG. 1.

Padded seat cover 150 preferably comprises zipper 154 allowing a means whereby occupant 180 may insert or remove padding. Padded seat cover 150 comprises padding to promote comfort of occupant 180. Padding may be increased or decreased with wear or according to user-preference. Upon reading this specification, it should be appreciated that, under appropriate circumstances, considering such issues as user preferences, design preference, structural requirements, marketing preferences, cost, available materials, technological advances, etc., other fastener arrangements such as, for example, snaps, buttons, clips, etc., may be sufficient.

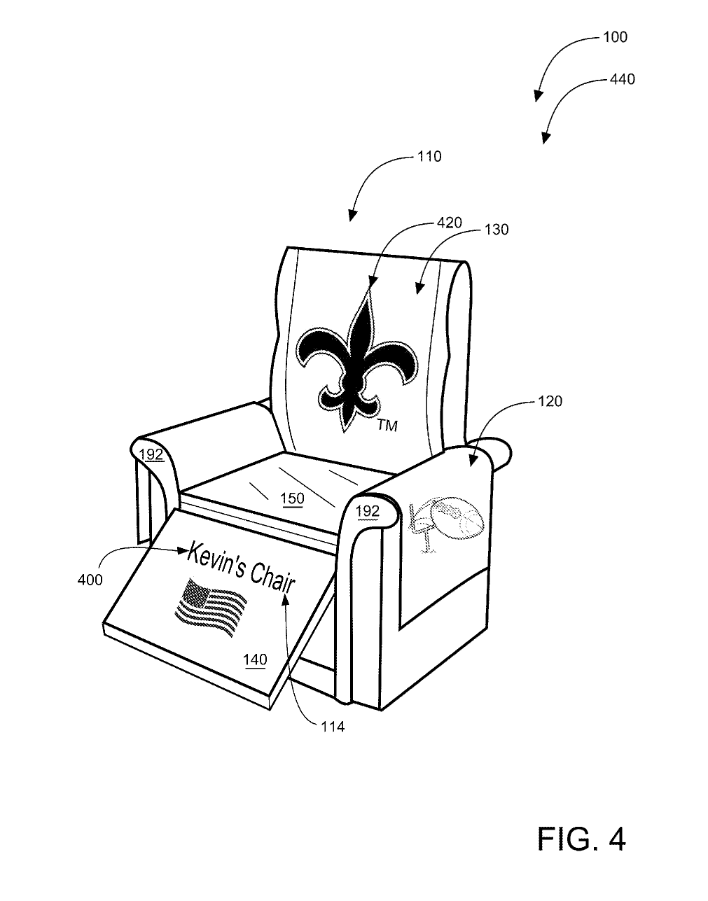

Referring now to FIG. 4, a perspective view illustrating furniture covering system 100 according to an alternate embodiment of the present invention of FIG. 1.

Coverings assembly 110 comprises markings 114. Markings preferably comprise indicia 400. Indicia 400 may be used to provide a visual indication of whom furniture item 190 belongs to or whom is permitted to sit in furniture item 190. Indicia 400 is preferably inter-changeable. Indicia 400 may comprise articles used by royalty such as a crown 410 for example as shown previously in FIGS. 1-3. Indicia may also comprises sports team logo 420 such as Nascar®, NFL, MLB, NHL, NBA, various school/universities, or a holiday theme such birthdays, Christmas and the like. Indicia 400 may be attached via Velcro® (hook and loop fasteners or other suitably equivalent means) making it easily removable and interchangeable.

Furniture covering system 100 may be sold as kit 440 comprising the following parts: at least two arm sleeves 120; headrest cover 130; footrest cover 140; padded seat cover 150; and fastening system 210. The items preferably comprise indicia 400 according to the preference of occupant 180. Furniture covering system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, different themes, parts may be sold separately, etc., may be sufficient. In certain embodiments the present invention may comprise furniture with the disclosed designs.

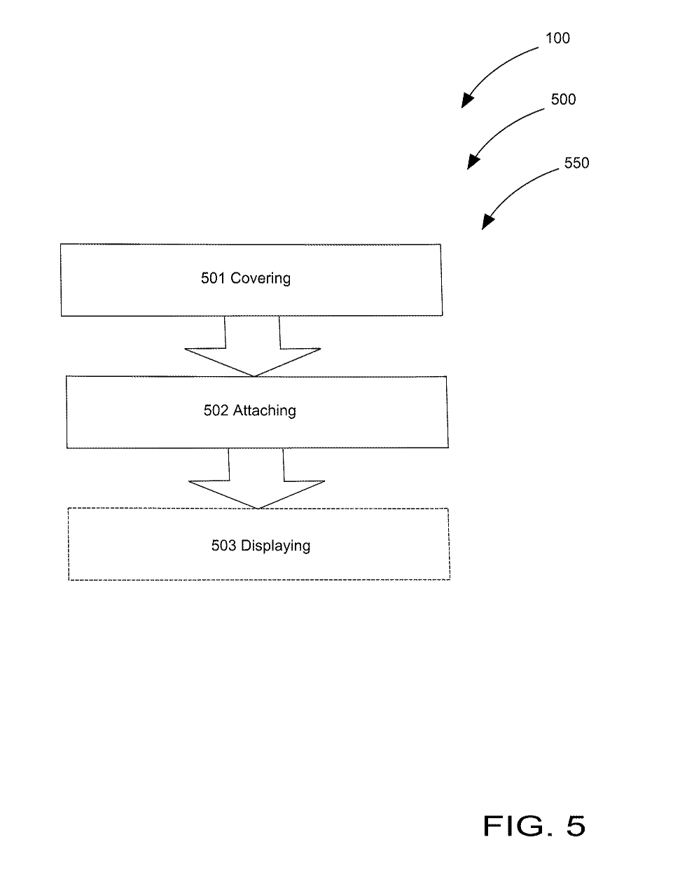

Referring now to FIG. 5, a flowchart illustrating a method of using (method of use 500) furniture covering system 500 according to embodiments of the present invention of FIGS. 1-4.

A method of using (enabling method of use 500) furniture covering system 100 preferably comprises the steps of: step one 501 covering arms 192, headrest 194, footrest 196 and seat 198 of a furniture item 190 with covering assembly 110; step two 502 attaching covering assembly 110 using fastening system 210 to furniture item 190 thereby preventing undue wear to furniture item 190; and step three 503 displaying indicia 400 on covering assembly 119 to indicate a proper occupant 189 of furniture item 190.

It should be noted that step 503 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A furniture covering system comprising:
a coverings assembly including;
at least two arm sleeves;
a headrest cover;
a footrest cover; and
a padded seat cover;
wherein said arm sleeves cover arms of a furniture item;
wherein said headrest cover covers a headrest of said furniture item;
wherein said footrest cover covers a footrest of said furniture item;
wherein said padded seat cover covers a seat of said furniture item;
wherein said coverings assembly is stain-resistant; and
wherein said coverings assembly provides comfort for an occupant of said furniture item and prevents undue wear of said furniture item.

2. The furniture covering system of claim 1 wherein said coverings assembly further comprises a fastening system.

3. The furniture covering system of claim 2 wherein said fastening system comprises a set of elastic straps.

4. The furniture covering system of claim 2 wherein said fastening system comprises hook and loop attachers.

5. The furniture covering system of claim 2 wherein said fastening system comprises elastic straps and hook and loop attachers.

6. The furniture covering system of claim 1 wherein said padded seat cover comprises a zipper.

7. The furniture covering system of claim 1 wherein said padded seat cover comprises removable padding to promote comfort of said occupant.

8. The furniture covering system of claim 1 wherein said furniture item comprises a chair.

9. The furniture covering system of claim 8 wherein said chair comprises a recliner.

10. The furniture covering system of claim 1 wherein said coverings assembly comprises markings.

11. The furniture covering system of claim 10 wherein said markings comprise indicia.

12. The furniture covering system of claim 11 wherein said indicia provides a visual indication of whom said furniture item belongs to.

13. The furniture covering system of claim 11 wherein said indicia provides a visual indication of whom is permitted to sit in said furniture item.

14. The furniture covering system of claim 11 wherein said indicia is inter-changeable.

15. The furniture covering system of claim 14 wherein said indicia comprises articles used by royalty.

16. The furniture covering system of claim 14 wherein said indicia comprises a sports team logo.

17. The furniture covering system of claim 1 wherein said indicia comprises a holiday theme.

18. A furniture covering system comprising
a coverings assembly including;
at least two arm sleeves;
a headrest cover;
a footrest cover;
a padded seat cover; and
a fastening system;
wherein said arm sleeves cover arms of a furniture item;
wherein said headrest cover covers a headrest of said furniture item;
wherein said footrest cover covers a footrest of said furniture item;
wherein said padded seat cover covers a seat of said furniture item;
wherein said padded seat cover comprises a zipper;
wherein said padded seat cover comprises removable padding to promote comfort of an occupant as per user-preference;
wherein said fastening system comprises a set of elastic straps and hook and loop fasteners to attach said coverings assembly to said furniture item;
wherein said furniture item comprises a reclining chair;
wherein said coverings assembly comprises markings;
wherein said markings comprise indicia;
wherein said indicia provides a visual indication of whom is permitted to sit in said furniture item;
wherein said indicia is inter-changeable as desired by said occupant;
wherein said coverings assembly is stain-resistant; and
wherein said coverings assembly provides comfort for said occupant of said furniture item and prevents undue wear of said furniture item.

19. A method of use for a furniture covering system comprising the steps of:
covering arms, headrest, footrest and a seat of a furniture item with a covering assembly;
attaching said covering assembly using a fastening system to said furniture item; and
preventing undue wear to said furniture item.

20. The method of claim 19 further comprising the step of displaying indicia on said covering assembly to indicate a proper occupant of said furniture item.
